(19) United States
(12) Patent Application Publication
(10) Pub. No.: US 2005/0204115 A1
(43) Pub. Date: Sep. 15, 2005

(54) Semiconductor memory device, memory controller and data recording method

(76) Inventors: Kiminori Matsuno, Katano City (JP); Masahiro Nakanishi, Yawata City (JP); Tomoaki Izumi, Neyagawa City (JP); Tetsushi Kasahara, Katano City (JP); Kazuaki Tamura, Toyono-gun (JP)

Correspondence Address: SMITH PATENT OFFICE, 1901 PENNSYLVANIA AVENUE N W, SUITE 200, WASHINGTON, DC, 20006, US

(21) Appl. No.: 11/043,411

(22) Filed: Jan. 27, 2005

(30) Foreign Application Priority Data
Jan. 30, 2004 (JP) 2004-022671

(51) Int. Cl. G06F 12/08

(52) U.S. Cl. 711/203; 711/103; 711/163

(57) ABSTRACT

A read/write memory 109 is provided with a memory controller 110 so as to store address management information temporarily. A non-volatile memory access unit 106 writes user data on a non-volatile memory 111 according to a write instruction. When the user data is rewritten, an address management information controller 105 causes a physical block, which is an object to which the address management information 108 is rewritten, to be a to-be-invalid block. After completion of a series of writing process, the to-be-invalid block is turned into an invalid block and the address management information in the read/write memory 109 is rewritten on the non-volatile memory 111.

### BACKGROUND OF THE INVENTION

1. Field of the Invention

The present invention relates to a semiconductor memory device using a non-volatile memory, a memory controller, and a data recording method.

2. Description of the Related Art

Memory cards such as SD memory cards and Compact Flash™ are small among semiconductor memory devices, so they are used practically as removable memory devices for portable equipment such as digital still cameras.

Generally, in a practically used semiconductor memory device, a flash memory is built in as a non-volatile memory, and further a memory controller LSI which is a control circuit thereof is incorporated. In recent years, due to increasing demands for larger capacity of a semiconductor memory device, the capacity of a non-volatile memory chip itself is also increasing by means of multi-valued cell. Further, due to advancement in the mounting technique, the number of chips of non-volatile memory mounted on a semiconductor memory device is increased, whereby one having a memory space exceeding 1 GB is coming into practical use as a semiconductor memory device.

As address management methods in semiconductor memory devices, there are disclosed two methods, that is, a distributed management method and a centralized management method. In the distributed management method, a flag showing the logical address and the state of a page is stored in the management area of a page which is a writing unit, and when initializing, an address management table and the like are formed in a RAM within the controller LSI. In the centralized management method, a special block for an address management table is prepared on the non-volatile memory, and when initializing, this block is read out to a RAM within the memory controller LSI.

In the distributed management method, it is required to read the management areas of all address spaces at the time of initialization, which causes a problem of a relatively long period being required for initialization. On the other hand, in the centralized management method, as an address space becomes larger, the capacity of the address management table, that is, the capacity of a read/write memory (such as RAM) within the memory controller LSI becomes enormous, which causes a problem of a relatively high cost. In order to solve the problem in the centralized management method, there is proposed a method in which all memory spaces are divided into a plurality of logical address ranges, and address management information such as an address management table is stored for each logical address range. (For example, see Japanese Patent Application Laid-open No. 2001-142774.)

However, a problem still remains in its reliability, because this art does not disclose a method to restore to the state before data writing, if power supply interruption is caused during data writing to a non-volatile memory or data rewriting.

### SUMMARY OF THE INVENTION

The present invention has been developed in view of these conventional problems. An object of the invention is to enable the memory device to be restored to the state before data writing, if power supply interruption is caused during data writing to a non-volatile memory or data rewriting, as described above.

A semiconductor memory of the present invention is used by connecting with an access device and reads and writes data according to a command and a logical address given by the access device. The semiconductor memory comprises: a non-volatile memory, composed of a plurality of physical blocks, for storing address management information and user data; and a memory controller, wherein the memory controller includes: a volatile read/write memory for reading out the address management information retained in the non-volatile memory and storing it temporarily; a non-volatile memory access unit for writing user data onto the non-volatile memory according to a write instruction from the access device, and upon completion of a series of write processing, rewriting the address management information temporarily stored in the read/write memory to the non-volatile memory; an address management information controller for sequentially updating the address management information temporarily stored in the read/write memory according to the write processing of the user data to the non-volatile memory; and a controller for controlling reading/writing of the user data from/to the non-volatile memory based on the address management information retained in the read/write memory, wherein when the user data is rewritten, the address management information controller causes a physical block, which is an object to which the user data is rewritten, to be a to-be-invalid block until completion of a series of write processing in the address management information temporarily stored in the read/write memory to thereby prohibit writing onto the to-be-invalid physical block.

A memory controller of the present invention is composed of a plurality of physical blocks and is used for a semiconductor memory device in which data is written onto and read from a non-volatile memory for storing address management information and user data. The memory controller comprises: a volatile read/write memory for reading out the address management information retained in the non-volatile memory and storing it temporarily; a non-volatile memory access unit for writing user data onto the non-volatile memory according to a write instruction from the access device, and upon completion of a series of writing process, rewriting the address management information temporarily stored in the read/write memory to the non-volatile memory; an address management information controller for sequentially updating the address management information temporarily stored in the read/write memory according to the writing process of the user data to the non-volatile memory; and a controller for controlling read/write of the user data from/to the non-volatile memory based on the address management information retained in the read/write memory, wherein when the user data is rewritten, the address management information controller causes a physical block, which is an object to which the user data is rewritten, to be a to-be-invalid block until completion of a series of write processing in the address management information temporarily stored in the read/write memory to thereby prohibit writing onto the to-be-invalid physical block.

A data recording method in a semiconductor memory device is the method that data is written on and read from a non-volatile memory storing address management information and user data. The method comprises the steps of: reading the address management information retained in the non-volatile memory and storing it temporarily in a volatile read/write memory; according to a write instruction of an access device, writing/reading the user data onto/from the non-volatile memory, based on the address management information retained in the read/write memory; sequentially updating the address management information temporarily stored in the read/write memory according to writing process of the user data to the non-volatile memory; and when rewriting the user data, causing a physical block, which is an object to which the user data is rewritten, to be a to-be-invalid block until completion of a series of writing process in the address management information temporarily stored in the read/write memory to thereby prohibit writing onto the to-be-invalid physical block; and upon completion of the series of writing process, rewriting the address management information temporarily stored in the read/write memory to the non-volatile memory.

According to the present invention, during a series of data writing, address management information corresponding to a physical area in which old data is rewritten is set to be in a to-be-invalid state, and writing is prohibited until a process of data writing ends. Thereby, even if a power supply interruption is caused during data writing, it is possible to be restored to the state before writing, that is, the state where the old data remains. As a result, it is possible to provide a semiconductor memory device, a memory controller and a data recording method with high reliability.

### BRIEF DESCRIPTION OF THE DRAWINGS

FIG. 1 is a block diagram showing the overall structure of a semiconductor memory device according to an embodiment of the present invention;

FIG. 2 is an illustration showing information storage areas of a non-volatile memory of the present embodiment;

FIG. 3 is an illustration showing a physical block of the present embodiment;

FIG. 4 is an illustration showing a logical address format of the present embodiment;

FIG. 5 is an illustration showing a physical management area table of the present embodiment;

FIG. 6 is an illustration showing an address conversion table of the present embodiment;

FIG. 7 is a time chart showing the writing sequence of the present embodiment;

FIG. 8 is an illustration showing the state of the logical address, the non-volatile memory and the physical area management table before writing new data onto a physical block in the present embodiment;

FIG. 9 is an illustration showing the state of the logical address, the non-volatile memory and the physical area management table after the new data is written on a physical block in the present embodiment;

FIG. 10 is an illustration showing the state of the logical address, the non-volatile memory and the physical area management table before rewriting data on a physical block in the present embodiment; and

FIG. 11 is an illustration showing the state of the logical address, the non-volatile memory and the physical area management table after the rewriting data is written on a physical block in the present embodiment.

### DESCRIPTION OF THE PREFERRED EMBODIMENTS

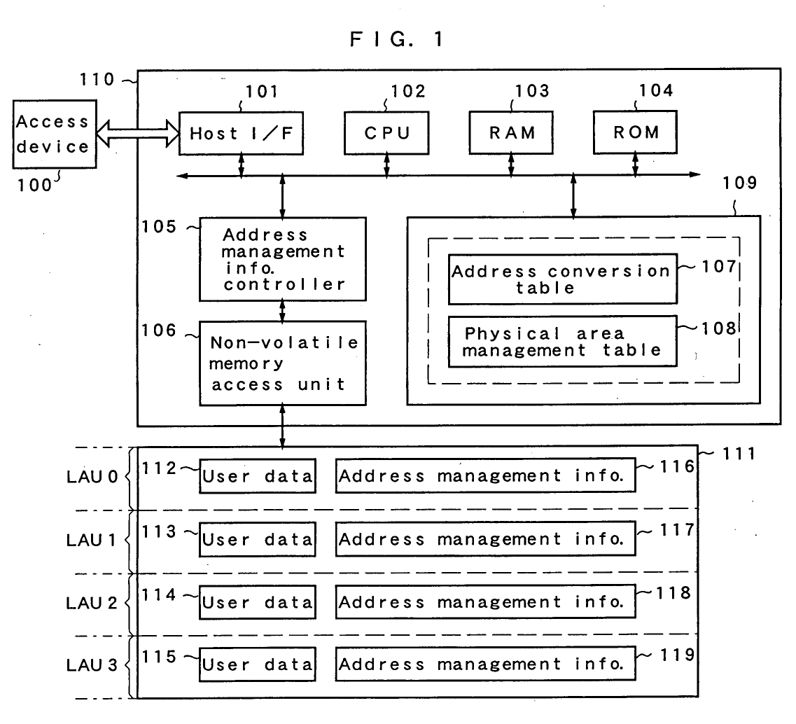

FIG. 1 is a block diagram showing the overall structure of a semiconductor memory device according to an embodiment of the present invention. The semiconductor memory device comprises a memory controller 110 and a non-volatile memory 111. An access device 100 is configured to transfer read/write instructions and the like to the non-volatile memory 111 via the memory controller 110. A host I/F 101 receives various instructions, logical addresses and writing data transferred by the access device 100. A CPU 102 is for controlling the memory controller 110 as a whole and controlling read/write of data. A RAM 103 is for a work of the CPU 102. A ROM 104 is for storing programs executed by the CPU 102. An address management information controller 105 is configured to sequentially update address management information temporarily stored in a read/write memory 109. A non-volatile memory access unit 106 is configured to read address management information in a logical address range for reading or writing data at the time of initialization, and to write user data onto the non-volatile memory 111 according to write instructions of the access device 100, and when writing of the user data is completed, to rewrite the address management information which has been temporarily stored in the read/write memory 109 to the non-volatile memory 111. The read/write memory 109 is a volatile memory for temporarily storing an address conversion table 107 and a physical area management table 108, and comprises a RAM for example. The address conversion table 107 is a table for converting a logical address transferred by the access device 100 via the host I/F 101 into a physical address of the non-volatile memory 111. The physical area management table 108 is a table for the status of use in the physical area of the non-volatile memory 111. The memory controller 110 is a controller comprehensively referring to the respective blocks described above.

The non-volatile memory 111 is a non-volatile main storage memory for storing address management information and user data, consisting of, for example, a flash memory. The non-volatile memory 111 is, for example, divided into four logical address ranges (LAU) 0-3 designated by the access device. In each of the logical address ranges 0-3, a plurality of physical blocks are formed, including an area for storing user data and an area for storing address management information. User data areas 112-115 are retained in the respective logical address ranges 0-3 designated by the access device 100, and are formed of a plurality of physical blocks. Pieces of address management information 116-119 corresponds to the logical address ranges 0-3, respectively, and are formed of a plurality of physical blocks. Note that a physical block means a minimum unit erasable selectively.

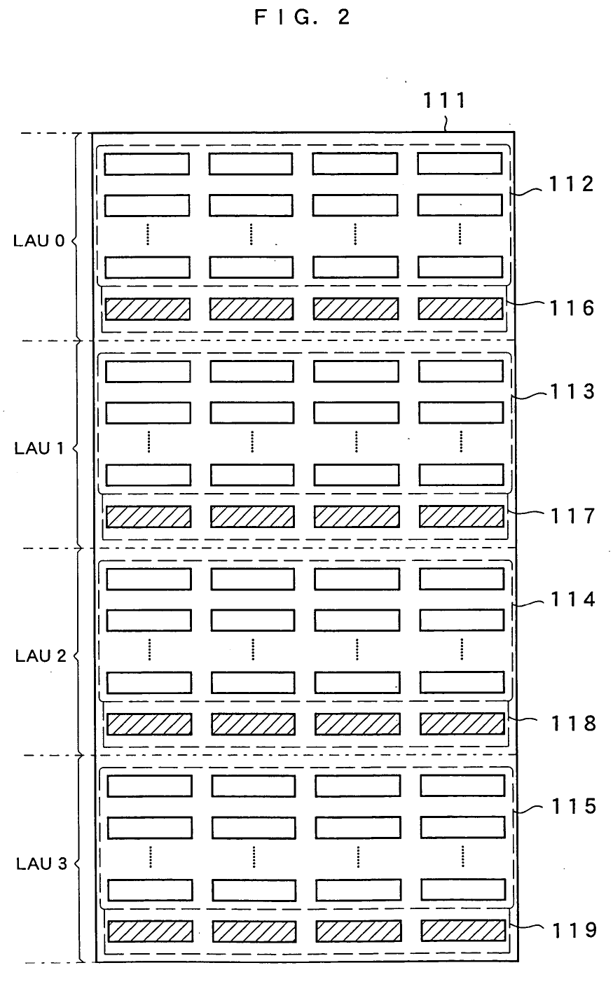

FIG. 2 is an illustration showing information writing areas of the non-volatile memory 111 according to the present embodiment. In FIG. 2, a number of rectangle blocks correspond to physical blocks. The non-volatile memory 111 is divided into four areas from a logical address range 0 to a logical address range 3. In respective areas, areas surrounded by broken line frames are user data areas 112-115, and areas 116-119 including hatched blocks are centralized address management areas for storing address management information.

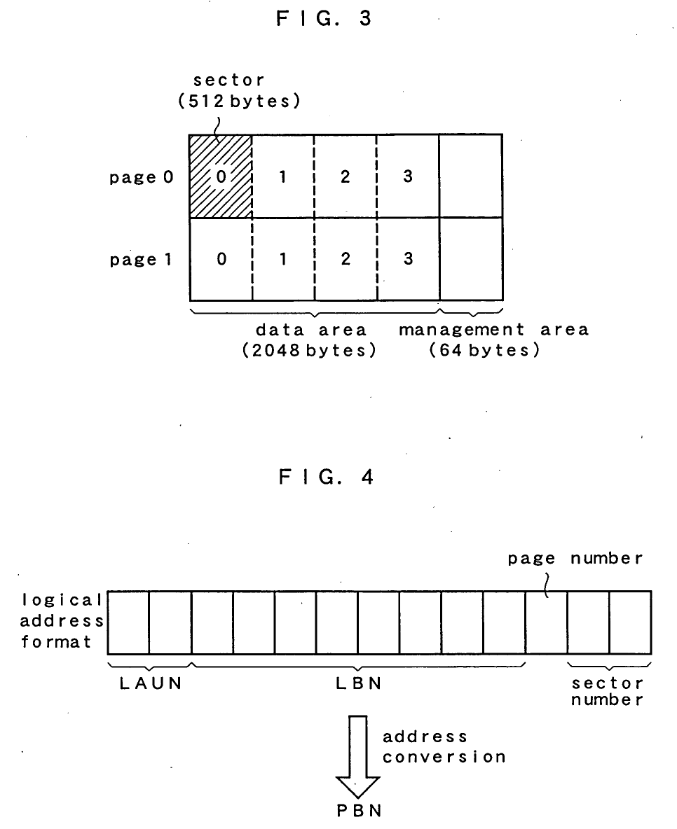

FIG. 3 is an illustration showing a physical block of the present embodiment. In this example, the physical block consists of two pages. One page is composed of four sectors from sector 0 to sector 3 (512 bytes each, total 2048 bytes) and a management area (64 bytes).

FIG. 4 is an illustration showing the logical address format of the present embodiment. In FIG. 4, a sector number, a page number, a logical block number (LBN) and a logical address range number (LAUN) are in sequence from the low-order bits. The eight-bit part corresponding to the logical block number is the object of address conversion, that is, the address of the address conversion table 107.

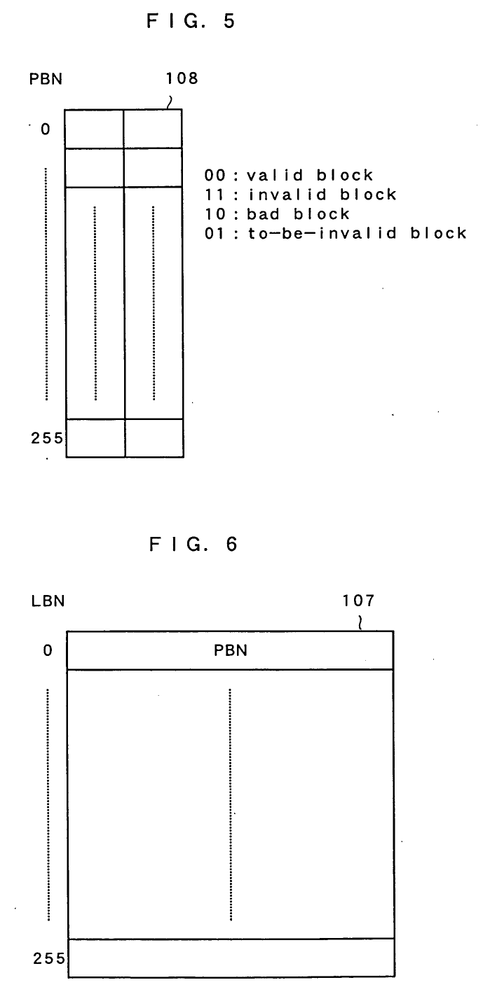

FIG. 5 is an illustration showing an information writing area of the physical management area table 108 in the present embodiment. In FIG. 5, addresses of the physical management area table 108 are respective physical block number (PBN) of the non-volatile memory 111, that is, the addresses of physical blocks, and the states (valid/invalid/bad/to-be-invalid) of respective physical blocks are stored. “00” in binary number means a valid block, indicating that valid data has been written in the physical block. “11” in binary number means an invalid block, indicating that the physical block is an erased block or a physical block of unnecessary data although data has been written. “10” in binary number means a bad block, indicating that the physical block cannot be used any more due to a solid error or the like on the memory cell. “01” in binary number means a to-be-invalid block. Assuming that the original data corresponding to the logical address rewritten to new data is old data in a predetermined writing period, a to-be-invalid physical block indicates that the old data is stored. When a series of data writing is completed normally, the physical block becomes an invalid block, so it is a to-be-invalid block temporarily until that time.

FIG. 6 is an illustration showing the address conversion table 107 of the present embodiment. In FIG. 6, the address is designated by the access device 100, which is the logical block number (LBN) corresponding to the logical address in FIG. 4. Each address stores a physical block number (PBN).

In the read/write memory 109, any one of address management information in the non-volatile memory 111 has been read at the time of initialization. The address management information of the non-volatile memory 111 has an address conversion table and a physical area management table which are almost same as that of the read/write memory. However, a to-be-invalid block within the physical area management table is set temporarily on the read/write memory 109, whereby it is not reflected in the address management information within the non-volatile memory 111.

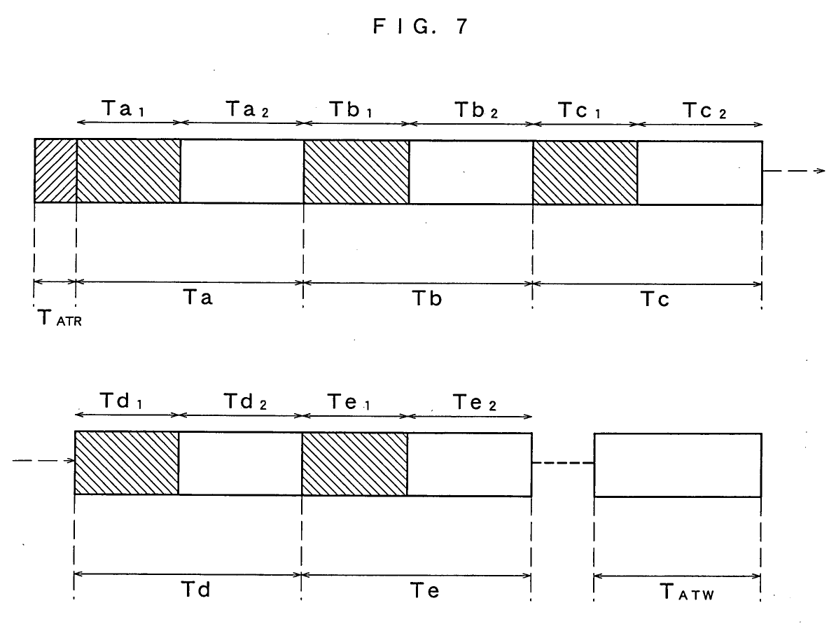

Explanation will be given for the operation of the semiconductor memory device of the present embodiment, configured as described above, by using FIGS. 1 and 7 to 11. FIG. 7 is an illustration showing the data writing sequence of the present embodiment. First, when the power source is turned on, the CPU 102 first performs initialization processing based on a program stored in the ROM 104, and then goes into a state of receiving commands such as reading/writing from the access device 100. Then, the access device 100 instructs to write into the logical address range 0.

The CPU 102 issues a read instruction to the non-volatile memory access unit 106, reads address management information corresponding to the logical address range 0 from the non-volatile memory 111, and transfers the information to the address conversion table 107 and the physical area management table 108 on the read/write memory 109. The address management information read at this point is the latest address management information existing in four physical blocks in the shaded area 116 within the logical address range 0 in FIG. 2. A decision of which one being the latest is performed by viewing, for example, a flag of the physical area management table. Specifically, a selection may be made on the premise that the latest address management information is retained in a physical block of most significant address (the upper rightmost side in the Figure) among valid blocks in the state of “00” within the shaded physical block.

The address management information lower-order than the physical block retaining the latest address management information (upper left direction in the Figure) may be erased as invalid blocks so as to be usable later. Since this is not essential processing in the present invention, explanation is omitted. An AT read period T_{ATR} in FIG. 7 is a time period of processing to read the address management information described above. AT stands for an allocation table which corresponds to address management information. The AT, that is, the address management information includes an address conversion table and a physical area management table. During the AT read period, a read command and an address are transmitted and address management information is received from the non-volatile memory 111. Then, a series of user data DataA, DataC, DataD are written in the logical address range 0, and DataB and DataE are rewritten. This processing corresponds to data write periods Ta to Te in FIG. 7.

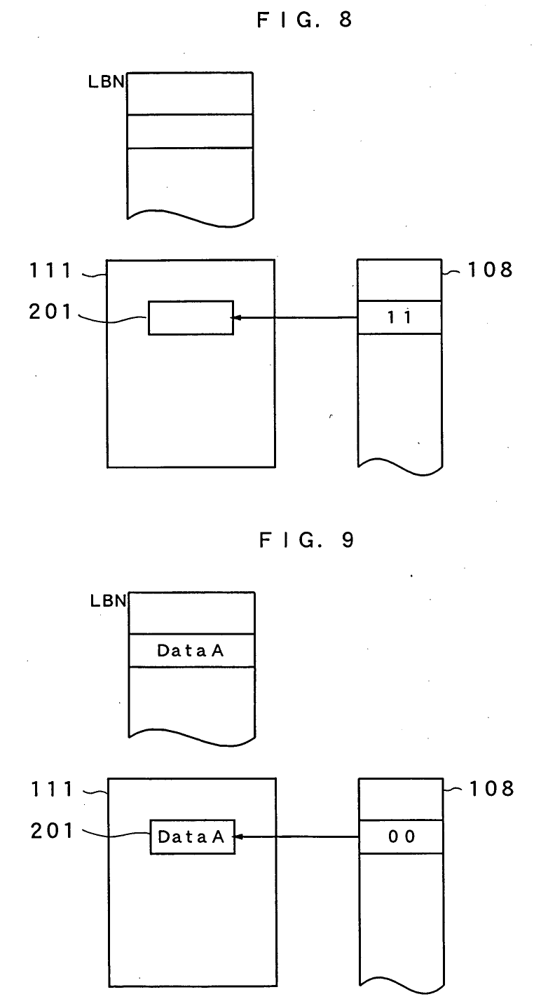

Each data writing period consists of a period of erasing a physical block which is the object of writing, that is, an erase busy period, and a period of writing onto the erased physical block, that is, a program busy period, based on transferring period (not shown) of a write command, an address and data. Since the data writing period Ta is a time period of newly writing data DataA on the logical address, old data does not exist. In such a case, the CPU 102 obtains an invalid physical block of “11” in binary number by referring to the physical area management table 108 on the read/write memory 109 shown in FIG. 8. Here, on condition that a physical block 201 is selected, the non-volatile memory access unit 106 accesses to the non-volatile memory 111 and erases data of the selected invalid physical block 201. The erase busy period Ta₁ is a time period of erasing this invalid block. Next, as shown in FIG. 9, data DataA is written on the physical block 201 after erasure. The program busy period Ta₂ is this writing period. At the timing when the program busy period Ta₂ is completed, the state of the physical block 201 as a writing destination becomes a valid block, or “00” in binary number in the physical area management table 108 of the read/write memory 109. Thereby, when the semiconductor memory device is viewed from the access device 100, the data DataA is written on the designated logical address.

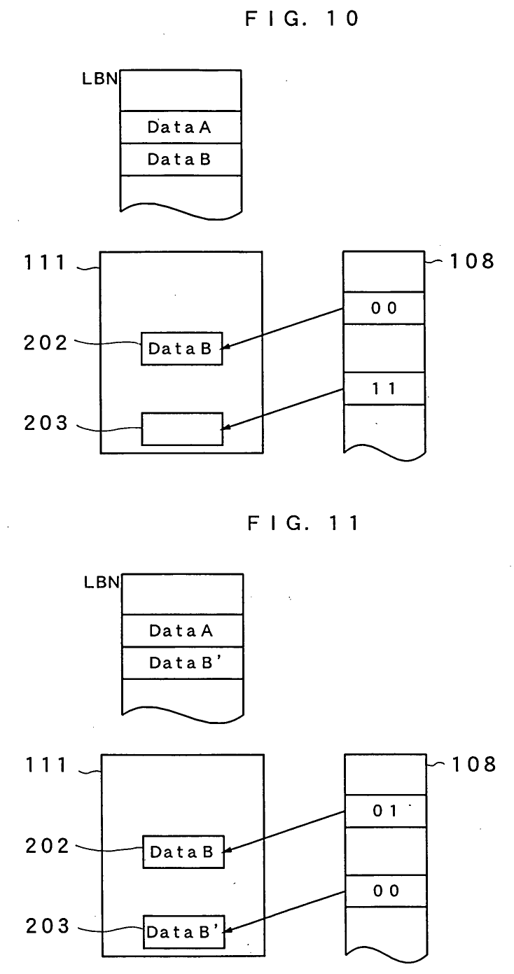

Next, in the data write period Tb, the data DataB is rewritten to DataB′ on the logical address. In such a case, the old data DataB exists in the physical block 202 corresponding to the designated logical address, as shown in FIG. 10. Accordingly, in addition to processing similar to the writing described above during the data write period Ta, it is required to cause the physical block 202, where the old data exits, to be an invalid block on the physical area management table 108. However, if the physical block 202 is caused to be an invalid block on the physical area management table 108 of the read/write memory 109, there is a possibility of the physical block being used in the subsequent data write periods Tc to Te, that is, a possibility of being erased and new data being written. If a failure such as a power source interruption is caused during a period from the time the semiconductor memory device is started to be used to the AT write period, the old data is rewritten without updating the address management information on the non-volatile memory 111, that is, not rewritten on the non-volatile memory 111. In such a case, a series of user data will never be restored to the state just before the writing process.

In view of the above, at the timing when the data write period Tb starts, the physical block 202 corresponding to the logical address for rewriting object, that is, the physical block 202 which has an old data DataB, is set to be a to-be-invalid block, or “01” in binary number. A to-be-invalid block is a prohibited physical block during the period of writing a series of user data. Then, a physical block in the invalid state, or a physical block 203 in this case, is selected in order to write new data, and a write command and an address and data are transferred. Then, data of the selected physical block 203 is erased in Tb₁. Next, as shown in FIG. 11, the data DataB′ is written on the selected physical block 203 in Tb₂. Then, at the timing when the data write period ends, the state of the physical block 203 for the writing destination is set to be a valid block (“00” in binary number) in the physical area management table 108 of the read/write memory 109.

Next, the data write periods Tc and Td are for new writing, so processing similar to that in the data write period Ta is performed. At this time, a to-be-invalid block is not selected as a new data write area.

The data write period Te is for rewriting, so processing similar to that in the data write period Tb is performed. At this time, the physical block where the old data exists is set to be a to-be-invalid block on the physical area management table 108, and new data is written on another invalid physical block. Even in this case, a to-be-invalid block is not selected as a new data write area.

Then, in the AT write period T_{ATW} in FIG. 7, when the physical area management table 108 of the read/write memory 109 updated as shown in FIGS. 9 and 11 is rewritten onto the non-volatile memory 111, the to-be-invalid block (“01” in binary number) is changed to an invalid block (“11” in binary number), and is written on the non-volatile memory 111. Thereby, a series of write processing from the data DataA to the data DataE is completed.

Now, explanation will be given for a case where the power supply is interrupted during a series of writing. For example, when the power supply is interrupted in the state where rewriting of the data DataB is completed, the contents of the tables 107 and 108 of the read/write memory 109 are not retained. Accordingly, when the power supply is recovered from the interruption, the content of the physical area management table within the address management information retained in the non-volatile memory 111 is read again into the physical area management table 108 of the read/write memory 109 by initialization processing. In such a case, it is restored to the original state shown in FIGS. 8 and 10. However, although the data DataA is written in the physical block 201 after recovery in FIG. 8, this data is disregarded since it is treated as an invalid block. Further, as for the physical block 202, the data DataB is retained as it is and this block is recorded as valid in the physical area management table in the non-volatile memory, so this data is treated as valid as it is. Further, since the physical block 203 in which the data DataB′ has been written is an invalid block, it is subject to rewriting in the subsequent processing.

As described above, according to the present invention, address management information corresponding to the physical area in which old data has been rewritten is made to be in a to-be-invalid state during writing of a series of data, and writing is prohibited until the series of writing ends, whereby it is possible to restore to the state before writing, that is, the state where the old data remains, even though a failure such as a power supply interruption is caused during data writing. As a result, it is possible to provide a semiconductor memory device with high reliability. Further, since information of the physical area management table is not rewritten in the address management information area within the non-volatile memory 111 during a series of writing, a series of write processing can be carried out at a higher speed comparing with the case of rewriting to the non-volatile memory one by one.

As the address conversion table 107 and the physical area management table 108, volatile read/write memories other than RAMs may be used if they can access at a relatively high speed. Further, the non-volatile memory 111 may incorporate a plurality of non-volatile memory chips. Further, as the non-volatile memory 111, a non-volatile memory other than a flash memory may be used. Further, although the pieces of address management information shown by the shaded blocks in FIG. 2 are stored in the respective logical address ranges, they may be stored collectively in a storing area for address management information allocated to, for example, the end of the non-volatile memory 111. Further, instead of the storing position of the address management information being fixed physically as the present embodiment, pointer information indicating the physical address of address management information may be provided separately and the address management information may be mixed in an area same as a user data area to thereby move the storing position corresponding to the pointer information.

The semiconductor memory device of the present invention can be used advantageously for various apparatuses which requires reading/writing of a large amount of data and high speed accessing, using a non-volatile memory. Such apparatuses include digital video cameras, digital still cameras, portable audio recording/playing back apparatuses.

1. A semiconductor memory device, which is used by connecting with an access device and reads and writes data according to a command and a logical address given by the access device, comprising: a non-volatile memory, composed of a plurality of physical blocks, for storing address management information and user data; and a memory controller, wherein the memory controller includes: a volatile read/write memory for reading out the address management information retained in the non-volatile memory and storing it temporarily; a non-volatile memory access unit for writing user data onto the non-volatile memory according to a write instruction from the access device, and upon completion of a series of write processing, rewriting the address management information temporarily stored in the read/write memory to the non-volatile memory; an address management information controller for sequentially updating the address management information temporarily stored in the read/write memory according to the write processing of the user data to the non-volatile memory; and a controller for controlling reading/writing of the user data from/to the non-volatile memory based on the address management information retained in the read/write memory, wherein when the user data is rewritten, the address management information controller causes a physical block, which is an object to which the user data is rewritten, to be a to-be-invalid block until completion of a series of write processing in the address management information temporarily stored in the read/write memory to thereby prohibit writing onto the to-be-invalid physical block.

2. The semiconductor memory device according to claim 1, wherein the address management information temporarily stored in the read/write memory includes: an address conversion table for converting a logical address given by the access device to a physical address; and a physical area management table for distinguishing a state of each physical block of the non-volatile memory by at least three types, that is, valid, invalid and to-be invalid, and in the series of write processing including rewriting of the user data which has been stored in the non-volatile memory, the address management information controller changes a state of a physical block where old data is stored when rewriting in the physical area management table to a to-be-invalid state indicating writing is prohibited, and when rewriting to the non-volatile memory, the to-be-invalid state is turned into an invalid state indicating writing is permitted to the physical area management table.

3. The semiconductor memory device according to claim 1, wherein the non-volatile memory is divided into a plurality of logical address ranges each of which is composed of a plurality of physical blocks, and each of the logical address ranges has a plurality of physical blocks for storing user data and a plurality of physical blocks for storing plural pieces of address management information.

4. The semiconductor memory device according to claim 3, wherein the read/write memory temporarily stores at least one address management information among the plural pieces of address management information corresponding to a logical address range given by the access device.

5. The semiconductor memory device according to claim 3, wherein the plural pieces of address management information are stored in the logical address ranges corresponding to the plurality of logical address ranges.

6. The semiconductor memory device according to claim 3, wherein the plural pieces of address management information are collectively stored in an area for address management information which is a predetermined physical area in the non-volatile memory corresponding to the plurality of logical address ranges.

7. A memory controller which is composed of a plurality of physical blocks and is used for a semiconductor memory device in which data is written onto and read from a non-volatile memory for storing address management information and user data, the memory controller comprising: a volatile read/write memory for reading out the address management information retained in the non-volatile memory and storing it temporarily; a non-volatile memory access unit for writing user data onto the non-volatile memory according to a write instruction from the access device, and upon completion of a series of writing process, rewriting the address management information temporarily stored in the read/write memory to the non-volatile memory; an address management information controller for sequentially updating the address management information temporarily stored in the read/write memory according to the writing process of the user data to the non-volatile memory; and a controller for controlling read/write of the user data from/to the non-volatile memory based on the address management information retained in the read/write memory, wherein when the user data is rewritten, the address management information controller causes a physical block, which is an object to which the user data is rewritten, to be a to-be-invalid block until completion of a series of write processing in the address management information temporarily stored in the read/write memory to thereby prohibit writing onto the to-be-invalid physical block.

8. The memory controller according to claim 7, wherein the address management information temporarily stored in the read/write memory includes: an address conversion table for converting a logical address given by the access device to a physical address; and a physical area management table for distinguishing a state of each physical block of the non-volatile memory by at least three types, that is, valid, invalid and to-be invalid, and in the series of writing process including rewriting of the user data which has been stored in the non-volatile memory, the address management information controller changes a state of a physical block where old data is stored when rewriting in the physical area management table to a to-be-invalid state indicating writing is prohibited, and when rewriting to the non-volatile memory, the to-be-invalid state is turned into an invalid state indicating writing is permitted to the physical area management table.

9. The memory controller according to claim 7, wherein the non-volatile memory is divided into a plurality of logical address ranges each of which is composed of a plurality of physical blocks, and each of the logical address ranges has a plurality of physical blocks for storing user data and a plurality of physical blocks for storing plural pieces of address management information, and the read/write memory temporarily stores, corresponding to a logical address range given by the access device, at least one address management information of the logical address range.

10. A data recording method in a semiconductor memory device in which data is written on and read from a non-volatile memory for storing address management information and user data, the method comprising the steps of: reading the address management information retained in the non-volatile memory and storing it temporarily in a volatile read/write memory; according to a write instruction of an access device, writing/reading the user data onto/from the non-volatile memory, based on the address management information retained in the read/write memory; sequentially updating the address management information temporarily stored in the read/write memory according to writing process of the user data to the non-volatile memory; and when rewriting the user data, causing a physical block, which is an object to which the user data is rewritten, to be a to-be-invalid block until completion of a series of writing process in the address management information temporarily stored in the read/write memory to thereby prohibit writing onto the to-be-invalid physical block; and upon completion of the series of writing process, rewriting the address management information temporarily stored in the read/write memory to the non-volatile memory.

11. The data recording method according to claim 10, wherein the address management information temporarily stored in the read/write memory includes: an address conversion table for converting a logical address given by the access device to a physical address; and a physical area management table for distinguishing a state of each physical block of the non-volatile memory by at least three types, that is, valid, invalid and to-be-invalid, and in the series of writing process including rewriting of the user data which has been stored in the non-volatile memory, the address management information controller changes a state of a physical block where old data is stored when rewriting in the physical area management table to a to-be-invalid state indicating writing is prohibited, and when rewriting to the non-volatile memory, the to-be-invalid state is turned into an invalid state indicating writing is permitted to the physical area management table.

12. The data recording method according to claim 10, wherein the non-volatile memory is divided into a plurality of logical address ranges each of which is composed of a plurality of physical blocks, and each of the logical address ranges has a plurality of physical blocks for storing user data and a plurality of physical blocks for storing plural pieces of address management information.

13. The data recording method according to claim 12, wherein the read/write memory temporarily stores, corresponding to a logical address range given by the access device, at least one address management information of the logical address range.

14. The data recording method according to claim 12, wherein the plural pieces of address management information are, corresponding to a plurality of logical address ranges, stored in the logical address ranges.

15. The data recording method according to claim 12, wherein the plural pieces of address management information are collectively stored in an area for address management information which is a prescribed physical area of the non-volatile memory corresponding to the plurality of logical address ranges.
